(19) United States
(12) Patent Application Publication
(10) Pub. No.: US 2009/0307857 A1
(43) Pub. Date: Dec. 17, 2009

(54) Device for a Pig

(75) Inventor: John Hestenes, Hafrsfjord (NO)

Correspondence Address: AKERMAN SENTERFITT, P.O. BOX 3188, WEST PALM BEACH, FL, 33402-3188, US

(73) Assignee: Sub Aqua Technology AS, 5018 Bergen (NO)

(21) Appl. No.: 12/442,666

(22) PCT Filed: Sep. 20, 2007
(86) PCT No.: PCT/NO07/00330

§ 371 Date: May 19, 2009

(30) Foreign Application Priority Data
Sep. 28, 2006 (NO) 20064392

(51) Int. Cl. B08B 9/047

(52) U.S. Cl. 15/104.061

(57) ABSTRACT

A device for a pig (1) for displacement by means of pressure differential in a pipe (8) where the pig (1) in addition to a pig body (2) comprises the necessary guides (4) and seals (6) against the pipe wall, and where the pig (1) is provided with a fluid motor (10), the fluid motor (10) being powered by fluid flowing through the fluid motor (10) due to the pressure differential across the pig (1).

This invention relates to a pig. More specifically it concerns a pig for displacement in a pipe by means of a differential pressure, where the pig, apart from a pig body, comprise the necessary guides and seals against the pipe wall, and where the pig is provided with a fluid motor, the fluid motor being powered by fluid flowing through the fluid motor due to pressure difference across the pig.

In the following the mode of operation of the pig is illustrated with reference to cleaning operations. This does not, however, limit the scope of the invention in any way.

It is quite common, during cleaning operations inside of pipelines to displace a pig in the pipe by means of pressure differential. Pigs for such work are provided with cleaning tools, for example in the form of brushes or scrapers adapted to be able to remove deposits like mineral salts, wax or oxides from the pipe wall. Said deposits may reduce the capacity of the pipeline. It may further be necessary to clean the line to be able to perform inspections.

Prior art employs pigs where the tool is stationary relative to the pig. The working speed of the cleaning tool during translation in the pipe is thus equal to the translation speed of the pig in the pipe.

It has turned out to be necessary to repeat the operation a few times to achieve sufficient cleaning of the pipe.

The object of the invention is to remedy or reduce at least one of prior art drawbacks.

The object is achieved according to the invention by the features stated in the description below and in the following claims.

A pig in accordance with the invention for displacement by means of a pressure differential in a pipe, where the pig in addition to a pig body comprises the necessary guides and seals against the pipe wall, is characterised in that the pig is provided with a fluid motor, the fluid motor being powered by fluid flowing through the fluid motor due to the pressure difference across the pig.

The fluid motor typically drives a tool via at least one transmission element, where the transmission element may be constituted by such as shafts, belts or gears.

Advantageously a cleaning body in the form of such as a brush or a grinding wheel may constitute the tool.

Advantageously the pig is provided with a magnet-controlled device to stop the fluid motor when the pig is positioned in a pipe with changed magnetic force between the device and the pipe. A valve connected to the flow channel of the fluid motor may for example constitute the magnet-controlled device. The valve is held in the open position by means of a magnet force towards the pipe wall when the pipe material is a magnetic material, but closes when the pig enters e.g. a pipe of non-magnetic material. Thereby the fluid motor stops.

Since the fluid motor drives a tool while the pig is translated in the pipe, cleaning operations may be made substantially more efficient. A driven rotating brush bearing against the pipe wall exhibits considerably higher removal rate than a brush being translated along the pipe wall at the speed of the pig.

In the following, an example of a preferred embodiment is described and illustrated in the enclosed drawings, where:

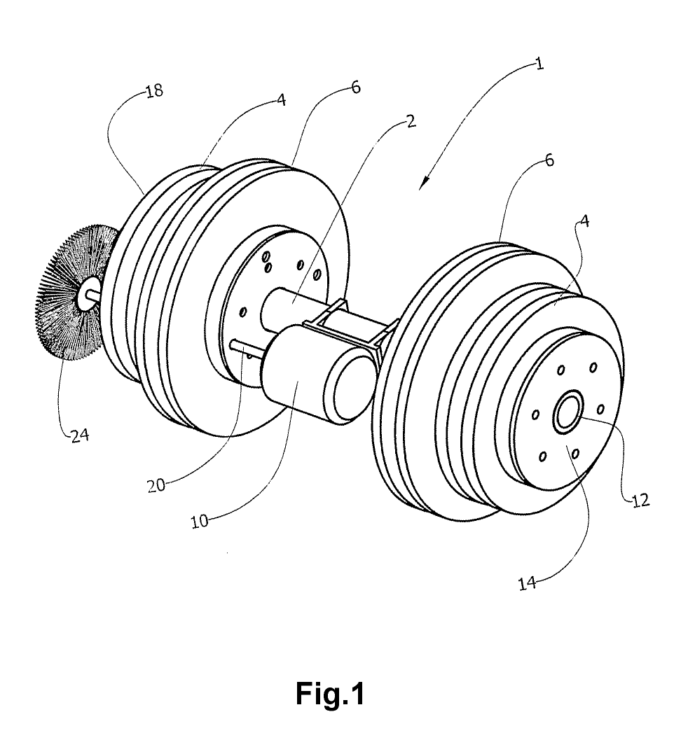

FIG. 1 shows a perspective view of a pig with a fluid motor mounted where only one motor is shown; and

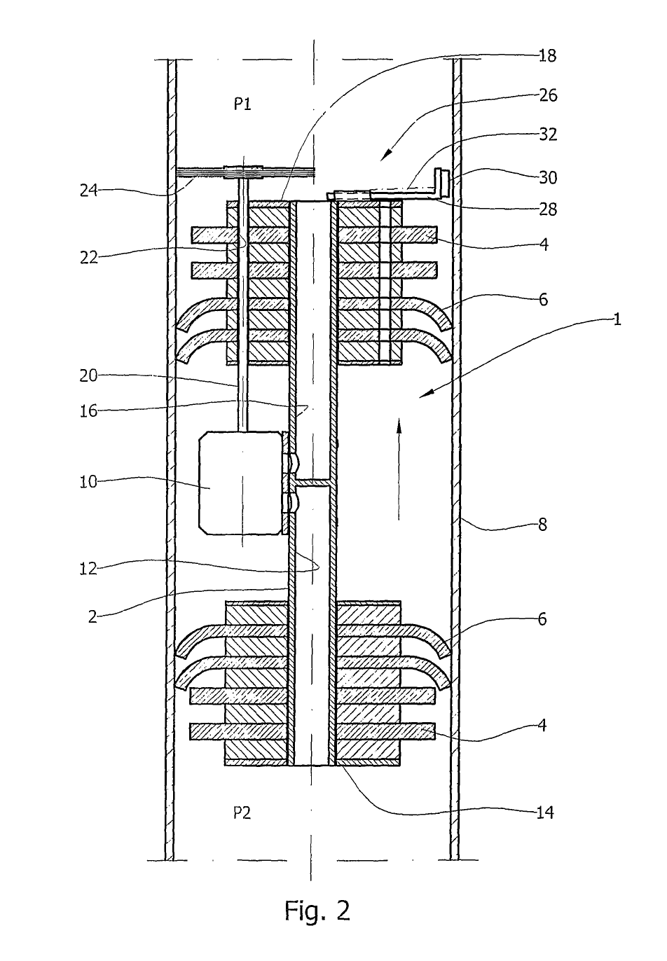

FIG. 2 shows schematically a section through the pig and a pipe, as the pig is positioned inside the pipe.

In the drawings, reference numeral 1 identifies a pig in accordance with the invention comprising a pig body 2, guides 4 and seals 6.

The pig 1 is arranged to be able to be displaced inside a pipe 8, see FIG. 2, by means of pressure differential. In FIG. 2 an arrow indicates direction of the pig displacement, as the pressure P1 in front of the pig 1 is less than the pressure P2 behind the pig 1.

A fluid motor 10 is connected to the pig body 2 and is fed fluid via a first channel 12 running from the rear portion 14 of the pig 1 to the fluid motor 10. Fluid flows on from the fluid motor 10 and via a second channel 16 running from the fluid motor 10 to the forward portion 18 of the pig 10. The channels 12 and 16 define the flow channels of the fluid motor.

In this preferred exemplary embodiment the channels 12, 16 run in the pig body 2. If the fluid motor 10 is arranged centrally in the pig 1, then the channels 12, 16 may possibly be positioned on the outside of the pig body 2.

A shaft 20 is connected to the fluid motor 10 and runs in a bearing 22 to the forward portion 18 of the pig 1 where the shaft 20 is connected to a brush 24.

A slide valve 26 is provided at the forward portion 18, and the slide 28 of the slide valve 26, in its closed position, closes the second channel 16. The slide 28 is provided with a magnet 30 arranged to hold the slide valve 26 in an open position as long as the pig is placed in a pipe 8 made of a magnetic material with certain magnetic properties.

The slide 28 is biased towards a closed position by a spring 32.

The hardness and relative dimensions of the seals among other things, decide the friction force between the pig 1 and the pipe 8. The pressure differential P2-P1, causing a fluid flow through the fluid motor 10, is essentially governed by said friction.

When the pig 1 is displaced in the pipe 8 by the pressure differential, fluid flows at the same time through the fluid motor 10 driving the brush 24 via the shaft 20. The brush 24, which thereby rotates about the central axis of the shaft 20, bears on the pipe 8 and cleans this and moves at the same time along the pipe 8.

If the pig comes into a pipe 8 made of a magnetically different material, the magnet 30 will no longer be able to hold the slide valve 26 in an open position, as the spring 32 will displace the slide 28 to a closed position and thereby stop the fluid motor 10.

In a practical embodiment the pig will be provided with multiple fluid motors 10 and multiple, usually counter-rotating brushes 24.

1. A pig to be displaced along a pipe by means of pressure differential in the pipe wherein the pig in addition to a pig body comprises:
guides and seals against the pipe wall;
a fluid motor, the fluid motor being powered by fluid flowing through the fluid motor due to the pressure differential across the pig; and
a magnet-controlled appliance to stop the fluid motor when the pig is positioned in a pipe with changed magnetic force between the appliance and the pipe.

2. A device according to claim 1, wherein the motor drives a tool via a transmission element.

3. A device according to claim 2, wherein the tool is a cleaning utensil.

4. A device according to claim 3, wherein the cleaning utensil is a brush.

5. A device according to claim 3, wherein the cleaning utensil is a grinding wheel.

6. (canceled)
